(19) United States
(12) Patent Application Publication
(10) Pub. No.: US 2008/0070211 A1
(43) Pub. Date: Mar. 20, 2008

(54) Illuminated rosary with audio assistance

(76) Inventors: Louis P. DeToma, Virginia Beach, VA (US); Marie B. Hendricks, Newport News, VA (US)

Correspondence Address: Galasso & Associates, LP, P.O. Box 26503, Austin, TX, 78755-0503, US

(21) Appl. No.: 11/524,013

(22) Filed: Sep. 19, 2006

(51) Int. Cl. G09B 19/00

(52) U.S. Cl. 434/245

(57) ABSTRACT

A prayer facilitator designed to assist a user in utilizing the prayer facilitator in the correct sequence and prayers for praying the Rosary in accordance with the traditions of the Roman Catholic faith. The Rosary includes a controller that is configured with a conventional integrated circuit board and memory that has stored therein a plurality of audio files containing the words to prayers required to complete the prayer of the Rosary. The controller further includes a switch and conventional audio electronics for subsequent retrieval and playing of the audio files. The Rosary further includes a control wire and plurality of prayer beads that operably connects the prayer beads to the controller. The prayer beads include at least one sensor configured to detect pressure thereon by a user.

### FIELD OF THE INVENTION

The present invention relates to a prayer facilitator, more specifically but not by way of limitation, a Rosary that further includes a controller that assists a user in praying the Rosary by illuminating the beads in the required sequence and by playing a recording of the prayer corresponding with the illuminated bead.

### BACKGROUND

Millions of individuals in the United States regularly practice some variety of religion. Religion is part of the core of our culture and its practices and beliefs are shared from generation to generation. Of the many different types of religions, the Roman Catholic religion is one of the most dominant religions in the United States and worldwide. It is estimated that there are over 40 million practicing Catholics in the United States alone.

Like other religions, the Roman Catholic religion utilizes many different rituals when engaging in practicing the faith. Prayer is one ritual that is engaged in by practitioners of the Roman Catholic religion. Different prayers and sequences of prayers are used in different settings such as the Apostle's Creed when celebrating a mass. One prayer ritual that is routinely used by practitioners of the Roman Catholic religion is the Rosary. The purpose of the Rosary is to help keep in memory and provide focus on certain principal events, or mysteries, in the history of the Catholic faith, and to thank, and praise, God for them. There are twenty mysteries reflected upon in the Rosary which are divided into the five Joyful Mysteries, the five Luminous mysteries, the five Sorrowful mysteries and the five Glorious mysteries. In order to pray with the Rosary correctly, adherents must repeat a series of prayers in the prescribed order, beginning with the Apostle's Creed and continuing through with a series of other prayers.

One issue with praying the Rosary is that it can be complicated and difficult to learn. A problem that faces practitioners in praying the Rosary is remembering not only the appropriate sequence of prayers but even the full content of the prayers themselves. Those practitioners who are just learning the Rosary can often find this discouraging which results in the dislike or discontinued praying of the Rosary. This same effect can happen on older or mentally challenged practitioners.

Accordingly, there is a need for a Rosary that can assist practitioners in not only remembering the proper sequence of the prayers but the content of the prayers that are required when praying with the Rosary in accordance with Roman Catholic religion.

### SUMMARY OF THE INVENTION

It is the object of the present invention to provide a Rosary that can assist a user with the proper sequence of prayers in accordance with the Roman Catholic religion.

It is a further object of the present invention to provide a Rosary that can assist a user with the proper sequence of prayers and assist the user with the content of each prayer in accordance with the Roman Catholic religion.

Yet another object of the present invention is to provide a Rosary that further includes a controller to assist a user with the proper sequence of prayers and assist the user with the content of each prayer in accordance with the Roman Catholic religion.

Another object of the present invention is to provide a Rosary that includes illumination in the Rosary beads as a method of assisting the user with the proper sequence of prayer when praying with the Rosary.

Still another object of the present invention to provide a Rosary that further includes an audio system to assist the user with the content of each prayer needed to pray with the Rosary.

To the accomplishment of the above and related objects the present invention may be embodied in the form illustrated in the accompanying drawings. Attention is called to the fact that the drawings are illustrative only. Variations are contemplated as being a part of the present invention, limited only by the scope of the claims.

### BRIEF DESCRIPTION OF THE DRAWINGS

A more complete understanding of the present invention may be had by reference to the following Detailed Description and appended claims when taken in conjunction with the accompanying Drawing wherein:

FIG. 1 is a perspective view of an embodiment of the present invention; and

FIG. 2 is a detailed view of an embodiment of one bead of the present invention.

### DETAILED DESCRIPTION

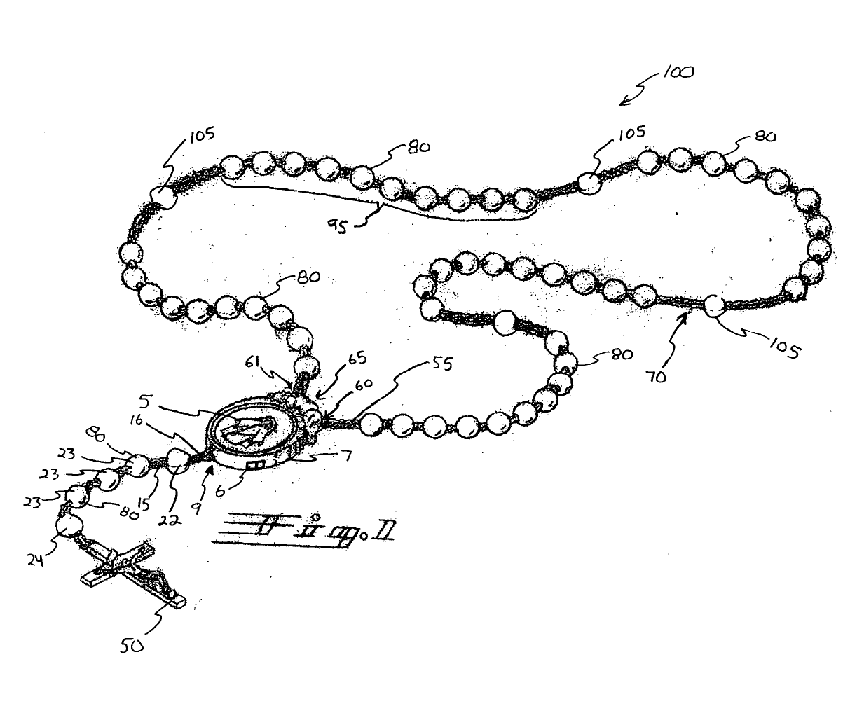

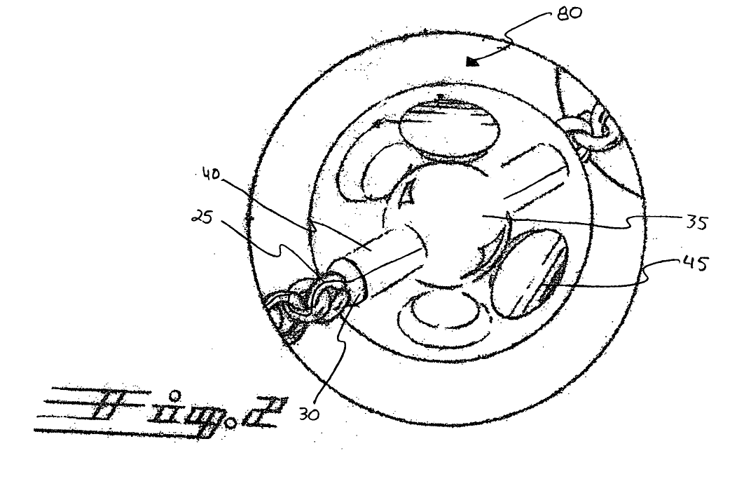

Referring now to the drawings submitted herewith wherein the various elements depicted therein are not necessarily drawn to scale and wherein like elements are identified with like reference numerals and in particular to FIGS. 1 and 2, there is illustrated a preferred embodiment of a mediation or prayer facilitator 100.

The prayer facilitator 100 comprises a controller 5 that is substantially oval in shape and is configured in a planar manner. The controller 5 has disposed therein an integrated circuit board, memory card and electronics necessary to receive, store and manipulate data. The controller 5 further includes conventional audio electronics necessary to receive, store and play conventional audio files. It is also contemplated within the scope of the present invention that the controller 5 further includes a renewable power source to provide the necessary power for the prayer facilitator 100. More specifically but not by way of limitation, the power source could be a conventional lithium ion or rechargeable nickel cadmium battery.

The controller 5 further includes a switch 6. The switch 6 functions to activate or deactivate the prayer facilitator 100. It is further contemplated within the scope of the present invention that the switch 6 could also function to pause the prayer sequence of the prayer facilitator 100. The controller 5 as shown in FIG. 1 is enclosed in a housing 7. The housing 7 is manufactured from a suitable durable material such as but not limited to metal or plastic. It is further contemplated within the scope of the present invention that the housing 7 have impressed substantially thereon the tradition symbol of the Mother Mary of the Roman Catholic religion. Those skilled in the art will recognize that numerous different symbols could be impressed thereon the housing 7 in place of and/or in conjunction with the symbol of the Mother Mary.

The housing 7 functions to provide protection for the controller 5 and the contents disposed therein and further serve as a traditional piece of a Roman Catholic Rosary.

Proximate one end 9 of the housing 7 and generally centrally connected thereto is an attachment mechanism 15. The attachment mechanism 15 functions to operably and physically connect the controller 5 to a plurality of prayer beads 80. The attachment mechanism 15 is manufactured from a durable and flexible material such as but not limited to chain link or string. It is also contemplated within the scope of the present invention that the attachment mechanism 15 also serves an ornamental function. More specifically, but not by way of limitation, the attachment mechanism 15 could be manufactured from precious metal chain links. The attachment mechanism 15 is further configured to include control wires 25 to journal therethrough (see FIG. 2). The control wires 25 function to transmit between the prayer beads 80 and the controller 5. The control wires 25 are manufactured from conventional wires or other suitable materials designed to transmit signals and data.

A portion 16 of the attachment mechanism 15 is secured to one end 9 of the controller 5. Integrally mounted along the portion 16 is a plurality of prayer beads 80. These prayer beads 80 are designed to signify to the user what prayers to recite when utilizing the prayer facilitator 100. Proximate to the controller 5 and securely mounted to the attachment mechanism is the prayer bead 22, which is used to signify to the user to recite the Glory Be prayer of the Roman Catholic religion. Secured adjacent to the prayer bead 22 continuing along a portion 16 of the attachment mechanism 15 are three more subsequent prayer beads 23 that are used to signify to the user to recite the Hail Mary prayer of the Roman Catholic religion. These beads 23 are adjacent to each other and are aligned along a portion 16 of the attachment mechanism 15.

Adjacent to the prayer beads 23 secured to the attachment mechanism 15 distal to the controller 5 is a prayer bead 24. The prayer bead 24 signifies to the user to recite the prayer Our Father of the Roman Catholic religion. Although it is contemplated within the scope of the present invention that the prayer facilitator 100 be used to pray the Rosary of the Roman Catholic faith, those skilled in the art will recognize that the prayer beads 80 could be utilized to signify to the user of the prayer facilitator 100 any numerous combinations of prayers or recitations for numerous different religions other than the prayers as intended by the traditions of the Roman Catholic church. Furthermore, those skilled in the art should recognize that the prayer facilitator 100 does not require any religious affiliation and could be used for meditation purposes.

Referring in particular to FIG. 2, the prayer beads 80 are manufactured from suitable durable materials such as plastic, metal, wood, natural or synthetic gemstones. The prayer beads 80 are secured to the attachment mechanism 15 by conventional mechanical or chemical methods. The prayer beads 80 have journaled centrally therethrough an aperture 30. The aperture 30 functions to provide a channel for the control wires 25 to operably connect to the prayer beads 80. The prayer beads 80 are generally round in shape. Those skilled in the art will recognize that the prayer beads 80 could be a plurality of different shapes in place of and/or in conjunction with the shapes of the prayer beads 80 as illustrated in the drawings submitted herewith.

Disposed substantially within the prayer beads 80 is a light 35. The light 35 is centrally disposed within the prayer beads 80 and generally encircles the wire support 40. The light 35 is operably connected to the controller 5 via control wires 25. The light 35 upon receiving information from the controller 5 illuminates in order to assist the user of the prayer facilitator 100 as to what prayer bead 80 should be used thus indicating the correct sequence to follow when praying the Roman Catholic Rosary. It should be recognized by those skilled in the art that the lights 35 disposed within the prayer beads 80 could be illuminated in numerous different sequences other than the suggested sequence of the Roman Catholic religion. The light 35 is manufactured from a conventional LED light. Those skilled in the art will recognize that numerous different types of conventional lights could be utilized in place of and/or in conjunction with the light 35. It is further contemplated within the scope of the present invention that the light 35 could be numerous different colors. Those skilled in the art will recognize that more than one light 35 could be utilized in each prayer bead 80.

It is further contemplated to be within the scope of this invention, that the pray beads 80 could be manufactured of materials and configured to be controlled by controller 5 stimulate the user in various other methods, such as, but not limited to being able to move or vibrate, or change colors.

Adjacent to the light 35 substantially disposed within the prayer bead 80 is a pressure sensor 45. The pressure sensor 45 is a conventional pressure sensor designed to detect pressure from the user subsequent to the user depressing on the prayer bead 80. It is contemplated within the scope of the present invention that the user could utilize the pressure sensor 45 to activate the prayers required by the prayer facilitator 100 for the Roman Catholic religion. Audio recordings of the prayers are stored in the memory of the controller 5. Subsequent to the depression of a prayer bead 80 having the pressure sensor 45 disposed therein, the controller 5 receives a signal that is transmitted via the control wires 25. The signal identifies which prayer bead 80 has been depressed thereby identifying to the controller 5 which prayer to broadcast via the electronic audio equipment disposed within the controller 5. While it is contemplated within the scope of the present invention that the each prayer bead 80 has associated therewith a designated prayer stored as a conventional audio file in the controller 5 for the Roman Catholic religion, those skilled in the art will recognize that the prayer beads 80 could have associated therewith numerous different audio recordings stored as conventional audio files in the controller 5.

In the drawings submitted herewith, the prayer beads 80 are illustrated with a four diametrically mounted pressure sensors 45. Those skilled in the art will recognize that numerous different amounts of pressure sensors 45 could be utilized to perform the intended function as described herein. More specifically but not by way of limitation only one pressure sensor 45 could be utilized per prayer bead 80. Furthermore, those skilled in the art will recognize that numerous different types of sensors could be utilized in place of and/or in conjunction with the pressure sensors 45. More specifically but not by way of limitation the prayer beads 80 could have disposed therein a heat sensor to detect heat from a user's hand area.

Integrally connected along the attachment mechanism 15 distally located from the controller 5 proximate the prayer bead 24 is a medallion 50. The medallion 50 in the drawings submitted herewith is shaped as the crucifix. In the Roman Catholic religion while using the prayer facilitator 100 to pray the Rosary, the medallion 50 signifies to the user to recite the Apostle's Creed. Those skilled in the art will recognize that the medallion 50 could be shaped in numerous different shapes in addition to the shape as described herein. Furthermore, the medallion 50 could be utilized to signify to a user of the prayer facilitator 100 to recite any number of prayers or meditate about a desired topic.

Extending from the controller 5 opposite the prayer bead 22 and integrally connected thereto is an upper attachment mechanism 55. The upper attachment mechanism 55 is manufactured similar to the attachment mechanism 15 as described herein. The upper attachment mechanism 55 is mounted by conventional mechanical or chemical methods at two points 60, 61 on the end 65 of the controller 5. Intermediate the two points 60, 61 the upper attachment mechanism 55 forms a loop 70. The loop 70 extends contiguously between points 60 and 61.

Disposed along the upper attachment mechanism 55 is a plurality of prayer beads 80. While the upper attachment mechanism 55 is illustrated in the drawings submitted herewith as having fifty-four beads, those skilled in the art will recognize that the upper attachment mechanism 55 could have numerous different amounts of prayer beads 80 in order to be utilized for different meditation or prayer objectives. The prayer beads 80 are generally organized in decades or groups 95 of ten with a space 85 and a single prayer bead 90 and an additional space 85 intermediate each group 95. There are five groups 95 of prayer beads 80 disposed along the upper attachment mechanism 55. Those skilled in the art will recognize that numerous different amounts of groups 95 of prayer beads 80 could be utilized and perform the desired function as described herein. It is contemplated within the scope of the present invention that each group 95 of ten prayer beads 80 are utilized to signify to the user to recite the Hail Mary prayer of the Roman Catholic religion. As previously described herein, each prayer bead 80 disposed along the upper attachment mechanism 55 has substantially disposed therein a light 35 and a plurality of pressure sensors 45. Control wires 25 are journaled through the upper attachment mechanism 55 to operably connect the prayer beads 80 to the controller 5. The light 35 and pressure sensor 45 are utilized to assist the user in utilizing the prayer facilitator 100 in the correct sequence and recite the required prayers in accordance with the Roman Catholic religion.

Interposed the spaces 85 intermediate each group is a single prayer bead 105. This single prayer bead 105 is utilized to signify to the user of the prayer facilitator 100 to recite the Glory Be prayer of the Roman Catholic religion. Those skilled in the art will recognize that the prayer bead 105 could be used to signify or represent numerous other prayers or mediation subjects other than the Glory Be as described herein.

In a preferred embodiment of the present invention that the prayer facilitator 100 operates in at least two general modes of operation. In one mode of use, a user will engage the switch 6 located on the controller 5 so as to activate the prayer facilitator 100. Subsequent to the prayer facilitator 100 being activated the controller 5 will send a signal to the first prayer bead 80 that is required to commence the appropriate sequence in order to prayer the Rosary for the Roman Catholic religion. The signal will illuminate the prayer bead 80. Simultaneous to the illumination of the prayer bead 80, the controller 5 will play using the conventional audio electronics, the appropriate prayer for the illuminated prayer bead 80. Upon completion of the prayer, the controller 5 will then send a signal to the next prayer bead 80 required for the appropriate sequence and again illuminate the prayer bead 80 and simultaneously play the appropriate prayer recording. This is continued until the entire sequence is completed. Those skilled in the art will recognize that the controller 5 could illuminate the prayer beads 80 in numerous different sequences other than the sequence as required by the Roman Catholic religion.

In the second contemplated mode of operation, a user will engage the prayer facilitator 100 and depress a desired prayer bead 80. The depression of the prayer bead 80 will activate the pressure sensor 45 substantially disposed therein. The pressure sensor 45 will send a signal via the control wire 25 to the controller 5. Subsequent to receiving the signal from the depressed prayer bead 80, the controller 5 will play the appropriate recording of the prayer that is stored in the controller 5 and is associated with the depressed prayer bead 80. It is also contemplated within the scope of the present invention that the prayer bead 80 subsequent to its depression by the user would further be illuminated during the playing of the recorded prayer by the controller 5.

In the preceding detailed description, reference has been made to the accompanying drawings that form a part hereof, and in which are shown by way of illustration specific embodiments in which the invention may be practiced. These embodiments, and certain variants thereof, have been described in sufficient detail to enable those skilled in the art to practice the invention. It is to be understood that other suitable embodiments may be utilized and that logical changes may be made without departing from the spirit or scope of the invention. The description may omit certain information known to those skilled in the art. The preceding detailed description is, therefore, not intended to be limited to the specific forms set forth herein, but on the contrary, it is intended to cover such alternatives, modifications, and equivalents, as can be reasonably included within the spirit and scope of the appended claims.

What is claimed is:

1. A device for assisting a user during at least one of meditation and pray, comprising:
a plurality of beads, with at least one of said plurality of beads operable to provide a stimulus to the user; and
a controller operably connected to said plurality of beads, said controller operable to control the operation of said at least one of said plurality of beads providing the stimulus to the user.

2. The device as recited in claim 1, and further including an illuminating device disposed within said at least one of said plurality of beads such that said illuminating device provides visual stimulus to the user.

3. The device as recited in claim 2, wherein said illuminating device includes a light.

4. The device as recited in claim 3, wherein said controller further operable to generate an audio stimulus corresponding to said at least one of said plurality of beads.

5. The device as recited in claim 4, wherein said at least one of said plurality of beads includes at least one pressure sensor, said at least one pressure sensor operably connected to said controller.

6. The device as recited in claim 5, wherein said controller being operable in at least two modes, such that when said controller is in said first mode, said controller illuminates said light and generates said audio stimulus, and further when said controller is in said second mode, said controller illuminates said light and generates said audio stimulus in response to said at least one pressure sensor.

7. A prayer facilitator comprising:
a plurality of beads, with each of said plurality of beads operable to provide a stimulus to the user; and
a controller operably connected to each of said plurality of beads, said controller operable to control the operation each of said plurality of beads providing the stimulus to the user.

8. The prayer facilitator as recited in claim 7, and further including an illuminating device disposed within at least one of said plurality of beads such that said illuminating device provides visual stimulus to the user.

9. The prayer facilitator as recited in claim 7, and further including a plurality of illuminating devices, with at least a single illuminating device of said plurality of illuminating devices disposed within each of said plurality of beads such that each of said plurality of illuminating devices operable to provide visual stimulus to the user.

10. The prayer facilitator as recited in claim 9, wherein said each of said plurality of illuminating devices includes a light.

11. The prayer facilitator as recited in claim 10, wherein said controller further operable to generate an audio stimulus corresponding to the illumination of each of said plurality of beads.

12. The prayer facilitator as recited in claim 11, wherein each of said plurality of beads includes at least one pressure sensor, with each of said at least one pressure sensors being operably connected to said controller.

13. The prayer facilitator as recited in claim 12, wherein said controller being operable in at least two modes, such that when said controller is in said first mode, said controller controls the illumination of each of said plurality of beads and generates said audio stimulus, and further when said controller is in said second mode, said controller controls the illumination of a select of said plurality of beads and generates said audio stimulus in response to pressure being applied to said at least one pressure sensor of said select of said plurality of beads.

14. A Rosary comprising:
a plurality of beads, with each of said plurality of beads operable to provide a stimulus to the user; and
a controller operably connected to each of said plurality of beads, said controller operable to control the operation each of said plurality of beads providing the stimulus to the user.

15. The Rosary as recited in claim 14, and further including an illuminating device disposed within at least one of said plurality of beads such that said illuminating device provides visual stimulus to the user.

16. The Rosary as recited in claim 14, and further including a plurality of illuminating devices, with at least a single illuminating device of said plurality of illuminating devices disposed within each of said plurality of beads such that each of said plurality of illuminating devices operable to provide visual stimulus to the user.

17. The Rosary as recited in claim 16, wherein said each of said plurality of illuminating devices includes a light.

18. The Rosary as recited in claim 17, wherein said controller further operable to generate an audio stimulus corresponding to the illumination of each of said plurality of beads.

19. The Rosary as recited in claim 18, wherein each of said plurality of beads includes at least one pressure sensor, with each of said at least one pressure sensors being operably connected to said controller.

20. The Rosary as recited in claim 19, wherein said controller being operable in at least two modes, such that when said controller is in said first mode, said controller controls the illumination of each of said plurality of beads and generates said audio stimulus, and further when said controller is in said second mode, said controller controls the illumination of a select of said plurality of beads and generates said audio stimulus in response to pressure being applied to said at least one pressure sensor of said select of said plurality of beads.
